(19) United States
(12) Patent Application Publication
(10) Pub. No.: US 2003/0103303 A1
(43) Pub. Date: Jun. 5, 2003

(54) Apparatus and installation method to optimize residential power factor

(76) Inventors: Roger Dale Barnes, Pensacola, FL (US); Lama Marcos, Orlando, FL (US)

Correspondence Address: Patricia E. McQueeney, Esq., Becker & Poliakoff, P.A., 3111 Stirling Road, Fort Lauderdale, FL, 33312, US

(21) Appl. No.: 10/294,052

(22) Filed: Nov. 14, 2002

(30) Foreign Application Priority Data
Oct. 21, 2002 (BR) 004877

(51) Int. Cl. H02H 9/00

(52) U.S. Cl. 361/58

(57) ABSTRACT

An apparatus and method for optimizing power factor in single-phase home power electrical systems. Advantages associated with the achievement of this objective include reduced electrical consumption and cost and prolonged equipment life. A capacitor circuit is connected with a circuit breaker to the home main power panel. The correct capacitance to optimize the power factor is determined prior to installation of the apparatus.

### BACKGROUND OF THE INVENTION

1. Field of the Invention

The instant invention relates to an apparatus and method for optimizing power factor in dwelling electrical installations, and in particular to a home unit and method of termination to optimize power factor.

2. Background of the Invention

Optimization of inductive loads is well known in the prior art. An inductive load is an electric current that results from a magnetic current. The magnetic current may be produced by an electric current passing through coils in an inductor, a transformer or the like, or the magnetic current may be produced by an electro magnet. Whatever its source, the inductive load always flows in an opposite direction to any change in the magnetic field. As the inductive load always acts in opposition to any change in the magnetic field, the inductive load is also known as a counter voltage or counter electromotive force (cemf). The inductive loads draw a combination of kilowatts (real power) and kilovars (apparent power).

The term “power factor” is used by persons of skill in the art to denote the equation: “real power divided by apparent power.” Some benefits associated with the optimization of power factor include increased equipment life due to lower operating temperature, protection against electrical surges such as those caused by lightning, and increased capacity at the electrical panel.

Capacitors are a static source of kilovars/capacitive power. Capacitors installed at equipment that have inductive loads provide a number of benefits: reduced electrical energy consumption, reduced line current, increased voltage at the load, better voltage regulation and lower losses. These benefits are accomplished by installing sufficient capacitors/kilovars at the load to bring the power factor to just under unity.

Inductive equipment that would benefit from power factor optimization include air conditioners, heat pumps, refrigeration equipment, irrigation pumps, pool pumps, etc. Other inventors have taken power factor correction technology to more complicated inductive equipment.

There are two types of power factor correction discussed in the prior art. The first type of power factor correction focuses on fluorescent lamps. Fluorescent lamps require large amounts of energy to ionize the gas contained therein, resulting in the production of light. The power factor optimization of fluorescent lamps focuses on preventing the harmonic interference introduced in the lamp circuit. Examples of fluorescent lamp power factor correction are provided in U.S. Pat. No. 5,095,253 to Brent; U.S. Pat. No. 5,498,936 to Smith; and U.S. Pat. App. No. 2002/00111801 A1 to Chang.

The second type of power factor correction is the application of capacitors to induction motors. Once again, there are several prior art references that address this issue.

U.S. Pat. No. 4,271,386 to Lee discloses an electronic controller for regulating power applied by an alternating current (AC) supply to an AC induction motor. Lee's electronic controller improves the power factor of the motor over a wide range of varying mechanical loads. Lee utilizes a thyristor switch, a transformer, resistors, and a capacitor. Lee limits his invention to AC induction motors.

U.S. Pat. No. 4,554,502 to Rohatyn discloses a power factor correcting system. Rohatyn states that some disadvantages with the use of capacitors to correct power factor are the resulting surge or spike the system experiences when the capacitor is switched and capacitor fuse blowing, which causes wattage loss. Rohatyn utilizes a fixed ratio series transformer, a variable autotransformer, a capacitor and a fuse. Rohatyn only discloses the use of his power factor correcting system for inductive loads.

The loads served by electric utility companies are generally primarily resistive (such as incandescent light bulbs) or primarily inductive (such as induction motors). The present invention steps back from the prior art focus on power factor correction in individual equipment. The present inventors have discovered that in small residential installations, the power factor of the entire house may be optimized at the house's main electrical breaker panel. In large residential, commercial and industrial settings, the power factor of individual components may be optimized at the load side of the component's switching device. Unfortunately, capacitors are not used to optimize load factor as widely as they might be. One reason for this has been the lack of a simple apparatus and method to optimize power factor. Utility company engineers have the technical background to size capacitors to correct power factor for electric utility companies, but in general, no such capability exists in the residential areas. As a result, more electrical energy than is necessary is used to power inductive loads, resulting in higher electricity bills.

### SUMMARY OF THE INVENTION

Accordingly, it is an object of this invention to provide an apparatus and method to optimize power factor in single-phase installations of the home. Invention features allowing the accomplishment of this object include a single-phase home unit and a simple method of termination. Advantages associated with these achievements include reduced electrical consumption, reduced electric bills, and prolonged equipment life.

It is still another object of the present invention to provide an apparatus and method of termination to optimize power factor whereby the required capacitance has been predetermined. Invention features allowing this object to be achieved include a large sampling of applications to determine a best-fit capacitance for the average dwelling. Advantages associated with this accomplishment include reduced electrical consumption, reduced electric bills, and prolonged equipment life.

### BRIEF DESCRIPTION OF THE DRAWINGS

The invention, together with the other objects, features, aspects and advantages thereof will be more clearly understood from the following in conjunction with the accompanying figures.

FIG. 1 is a front isometric view of a single-phase home unit.

FIG. 2 is an electrical schematic of a single-phase home unit depicting the recommended termination method to optimize power factor in the home.

FIG. 3 is circuit diagram of one embodiment of the present invention.

### DETAILED DESCRIPTION OF THE PREFERRED EMBODIMENTS

The terms “single-phase home power factor correction unit,” “single-phase home unit” and “home unit” are used interchangeably throughout this specification.

The terms “dwelling,” “home,” “house,” and “residential facility” are used interchangeably throughout this specification.

The term “load” refers to anything plugged into or connected to power lines.

The present invention provides a means to optimize the power factor of an entire house by terminating the home unit to the main electric power supply of a house. The novelty of the present invention lies in correcting many pieces of inductive equipment at one time, rather than, as in the prior art, attaching power factor correction equipment to each piece of equipment. The means for optimizing the power factor of an entire house include any of the prior art circuits utilized to correct power factor and installed at the main electric power supply of the house. However, the preferred embodiment of the present invention is provided in the following figures and their detailed description.

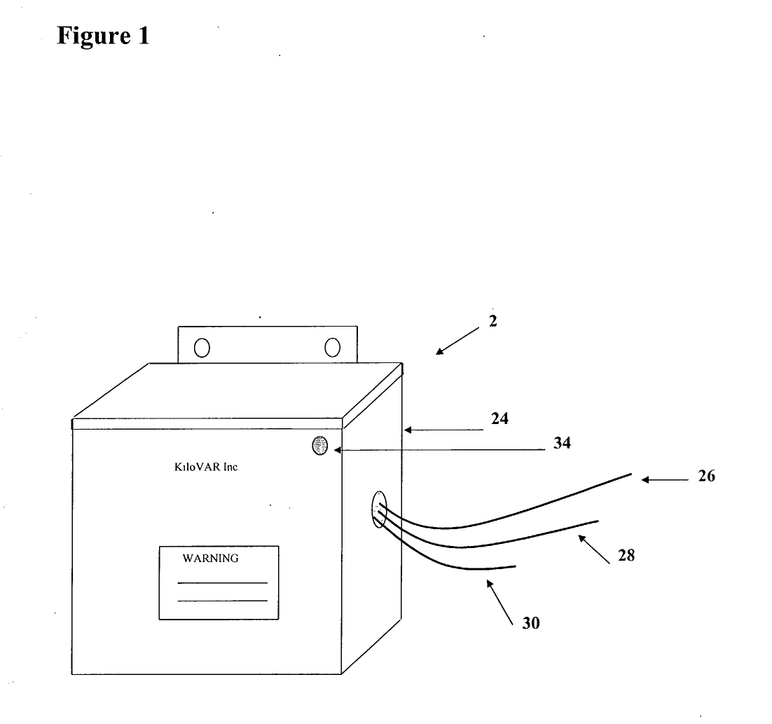

FIG. 1 is a front isometric view of a single-phase home unit 2. The home unit 2 of FIG. 1 is shown as a three-dimensional square. However, one of ordinary skill in the art would realize that the invention could be practiced utilizing any shape as long as the internal components were protected. Additional shapes include, but are not limited to, circular, cylindrical, rectangular and the like.

First single-phase lead 26, second single-phase lead 28 and ground lead 30 connect one or more capacitors to the electrical load whose power factor is being optimized. The electrical load whose power factor is being optimized can include residential, commercial and industrial facilities. In the preferred embodiment, the home unit 2 described herein is used on residential facilities. The leads are comprised of material suitable for their surroundings. The home unit 2 is constructed of materials suitable and safe for adverse weather conditions.

A light 34 is visibly lighted when the home unit 2 is energized and also acts as a bleed-down resistor when the home unit 2 is disconnected from service. The light 34 can be any color and located anywhere on the home unit 2.

Most of the single-phase home unit 2 components are contained within enclosure 24, with the leads 26, 28, 30 and the light 34, discussed above, being the only components located on the outside of the home unit enclosure 24. Of course, the home unit 2 may include warnings standard in the field, as is depicted in FIG. 1. Also, based on the physical and geographic location of the home unit 2, the home unit enclosure 24 may be designed to withstand weather conditions, such as snow, wind, rain and the like, possibly by the inclusion of vents or slats. The home unit enclosure 24 is made of materials suitable to the climate in which it is located. For example, a home unit enclosure 24 located outside the home in a tropical environment may be made of sealed concrete to prevent the growth of mold and fungus. A home unit enclosure 24 located outside the home in New England may be made of galvanized metal. Whereas a home unit enclosure 24 located inside the home may be made of stainless steel. The materials of which the home unit enclosure 24 is made are not limited to those disclosed herein. One of ordinary skill in the art would be able to adapt the material of the home unit enclosure 24 to best suit its environment.

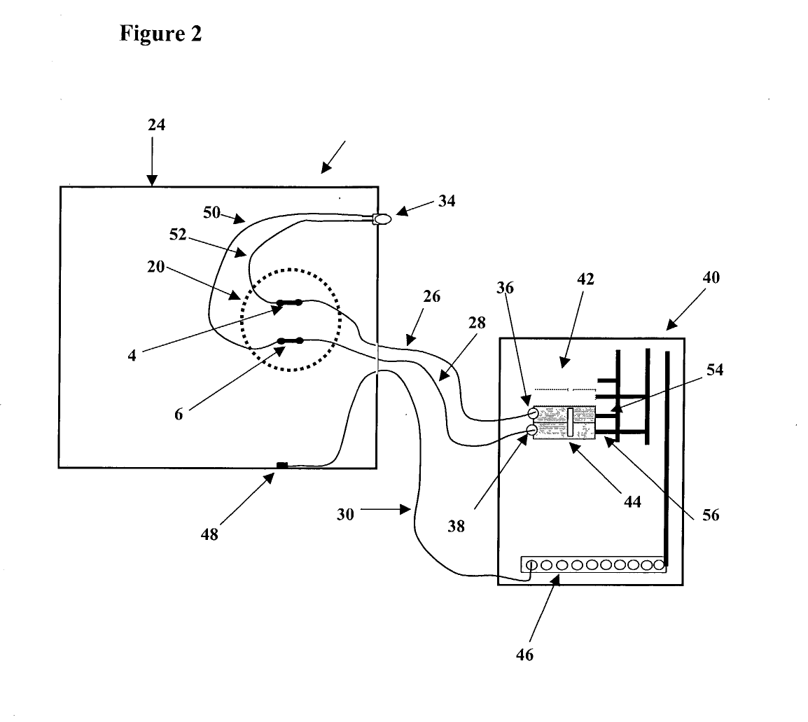

FIG. 2 is an electrical schematic of a single-phase home unit 2 connected to a dwelling main power panel 40. As shown in FIG. 2, the home unit 2 is adjacent to the dwelling main power panel 40. However, one of ordinary skill in the art would be able to locate the home unit 2 anywhere and utilize leads 26, 28 and 30 to connect the home unit 2 to the dwelling main power panel 40. As discussed above, the home unit 2 may be located inside or outside the home.

Single-phase home unit 2 comprises a single-phase capacitor 20. Single-phase capacitor 20 can be one or more capacitors connected in series, in parallel or in series-parallel. Each individual capacitor in the single-phase capacitor 20 can be passive; aluminum electrolytic, film, power film, metallized polyester, film/foil polyester metallized polypropylene, polypropylene film with double sided electrodes or solid tantalum; radial-metal can, axial-metal can, surface mount, metal can, surface mount, epoxy molded case, axial-tapewrap, radial-dip, or radial-box; comprising a capacitance range of 0.5 kVAR to 200 kVAR; and a voltage range of 110 VAC to 600 VAC. In the preferred embodiment utilized on a residential dwelling, any capacitor or combination of capacitors with the proper capacitance value as determined by one of ordinary skill in the art can be used as the single-phase capacitor 20.

The single-phase capacitor 20 is electrically connected to a first single-phase capacitor terminal 4 and a second single-phase capacitor terminal 6. This electrical connection is usually part of the capacitor design. However, the present invention is not limited to such design and any method of connection known in the art may be utilized. The capacitor terminals, 4 and 6, of the present invention comprise at least two connection points. First single-phase capacitor terminal 4 is electrically connected to first single-phase lead 26 and to first single-phase light lead 52. The second single-phase capacitor terminal 6 is electrically connected to second single-phase lead 28 and to second single-phase light lead 50.

A light 34 is electrically connected by first and second single-phase light leads 50 and 52. Ground lead 30 is electrically connected to the enclosure 48 and electrically connected to the main power panel ground terminal 46.

Although never intended, on occasion electronic circuitry experiences overload. This occurs when the electric load present in the circuitry is larger than the circuitry was designed to handle. The present invention may include an overload protection device 44, which is electrically connected between first single-phase lead 26 and first single-phase line bus 54. The overload protection device 44 of the present invention electrically isolates the first single-phase lead 26 from the first single-phase line bus 54 in case of an overload condition in first single-phase lead 26. An overload protection device 44 may also be electrically connected between second single-phase lead 28 and second single-phase line bus 56. Again, the overload protection device 44 electrically isolates the second single-phase lead 28 from the second single-phase line bus 56 in case of an overload condition in second single-phase lead 28. Non-limiting examples of overload protection devices include fuses or circuit breakers.

In one preferred embodiment of the present invention, there is one single-phase capacitor 20, having a capacitance value of 80 microfarads and a working voltage rating of 440 VAC. The overload protection device 44 is a 20 amp circuit breaker. Enclosure 24 is made of metal.

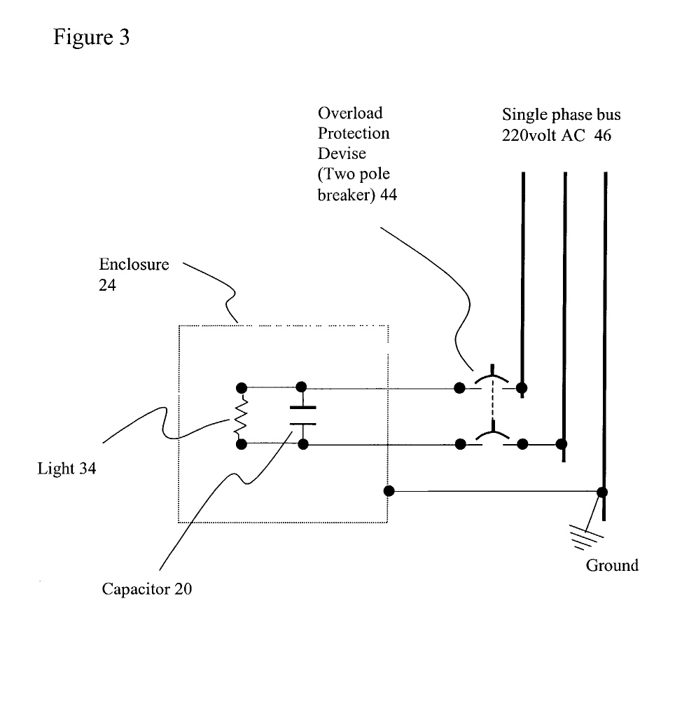

FIG. 3 provides the circuit diagram for another embodiment of the present invention. In this embodiment, the light 34 and the capacitor 20 are connected in parallel. Both are located within enclosure 24. The optional overload protection device 44 is provided as a two-pole circuit breaker.

### Termination of Single-phase Kilo VAR home Unit 2

FIG. 2 shows single-phase home unit 2 connected to a dwelling main power panel 40 to optimize the power factor in the single-phase power panel 40.

In the field of electronics, termination means to electrically connect to each other. In the present invention, the home unit 2 is connected to the main power panel of a house. The preferred method of termination for single-phase home unit 2 is as follows:

A. open single-phase overload protection device 44, such as a circuit breaker;

B. electrically connect first single-phase lead 26 to first single-phase circuit breaker terminal 36;

C. electrically connect second single-phase lead 28 to second single-phase circuit breaker terminal 38;

D. electrically connect ground lead 30 to power panel ground bus 46;

E. close single-phase overload protection device 44; and

F. observe indicator light 34 illumination indicating proper operation.

The following table provides the average monthly cost and kilowatt usage in a residential dwelling before and after installation of one embodiment of the present invention. It is interesting to note that the number of people living in the dwelling actually increased, and therefore it can be extrapolated that power consumption increased, after installation of one embodiment of the present invention. However, the utility bill after installation is over fifteen percent (15%) lower than prior to installation.

TABLE 1

| | | | Average | |
|---|---|---|---|---|
| | | | Monthly | |
| | | KiloWatts | Temperature | Average Monthly |
| Month | Year | Used | (° F.) | Cost |
| August | 2001 | 2261 | 83 | 214.77 |
| September | 2001 | 2042 | 81 | 194.93 |
| October | 2001 | 1556 | 75 | 150.92 |
| November | 2001 | 1071 | 69 | 106.99 |
| | Average | 1732.5 | 77 | 166.90 |
| March | 2002 | 823 | 67 | 83.10 |
| May | 2002 | 1548 | 77 | 134.91 |
| June | 2002 | 1910 | 81 | 164.34 |
| August | 2002 | 1969 | 83 | 172.68 |
| | Average | 1562.5 | 77 | 138.76 |
| BEFORE | | 1732.5 | 77 | 166.90 |
| AFTER | | 1562.5 | 77 | 138.76 |
| | Difference | 170 | | 28.14 |
| | Savings at | $13.60 | | |
| | $0.08 kwh | | | |

Table 2 provides a comparison of the utility bill for August before and after installation of the present invention for the same household. Again, although this household experienced an increase in the number of residents, the present invention provided almost a twenty percent (20%) reduction in utility costs.

TABLE 2

| | | | Kilo- | | Ave. |
|---|---|---|---|---|---|
| | | | Watts | Average Monthly | Monthly |
| | Month | Year | Used | Temperature (F.) | Cost |
| BEFORE | August | 2001 | 2261 | 83 F. | 214.77 |
| AFTER | August | 2002 | 1969 | 83 F. | 172.68 |
| | | Difference | 292 | | 42.09 |
| | | Savings at | $23.36 | | |
| | | $0.08 kwh | | | |

While preferred embodiments of the present invention have been illustrated herein, it is to be understood that changes and variations maybe made by those skilled in the art without departing from the spirit and scope of the appending claims.

I claim:

1. A single-phase home power factor correction unit comprising:
means for optimizing the power factor of an entire house.

2. A method of termination for the single-phase home power factor correction unit of claim 1 comprising:
attaching said home power factor correction unit to a main power panel of a dwelling.

3. A method of termination for the single-phase home power factor correction unit of claim 1 comprising:
A. opening a single-phase overload protection device;
B. electrically connecting said first single-phase lead to a first terminal of said overload protection device;
C. electrically connecting said second single-phase lead to a second terminal of said overload protection device;
D. electrically connecting said ground lead to a power panel ground bus;
E. closing said single-phase overload protection device; and
F. observing the illumination of an indicator light.

4. A single-phase home power factor correction unit comprising an enclosure comprising:
A. a first single-phase capacitor terminal electrically connected to a single-phase capacitor;
B. a second single-phase capacitor terminal electrically connected to said single-phase capacitor;
wherein said first single-phase capacitor terminal is electrically connected to both a first single-phase lead and a first single-phase light lead;
wherein said second single-phase capacitor terminal is electrically connected to both a second single-phase lead and a second single-phase light lead;
C. a light electrically connected to said first single-phase light lead and said second single-phase light lead; and
D. a ground lead electrically connected to the single-phase home power correction unit enclosure.

5. The single-phase home power factor correction unit of claim 4 wherein said ground lead is additionally electrically connected to a ground terminal on a main power panel.

6. The single-phase home power factor correction unit of claim 4 wherein an overload protection device is electrically connected between said first single-phase lead and a first single-phase line bus of a main power panel.

7. The single phase home power factor correction unit of claim 6 wherein said overload protection device is a 20 amp circuit breaker.

8. The single-phase home power factor correction unit of claim 4 wherein an overload protection device is electrically connected between said second single-phase lead and a second single-phase line bus of a main power panel.

9. The single phase home power factor correction unit of claim 8 wherein said overload protection device is a 20 amp circuit breaker.

10. The single-phase home power factor correction unit of claim 4 wherein said capacitor has a capacitance value of about 80 microfarads and a working voltage rating of about 440V AC.

11. The single-phase home power factor correction unit of claim 4 wherein the capacitance value of said capacitor varies with various voltage applications.

12. The single-phase home power factor correction unit of claim 4 wherein said capacitor is comprised of multiple single-phase capacitors.

13. The single-phase home power factor correction unit of claim 12 wherein said multiple single-phase capacitors have a capacitance value of about 80 microfarads and a working voltage rating of about 440V AC.

14. The single-phase home power factor correction unit of claim 12 wherein the capacitance value of said multiple single-phase capacitors varies with various voltage applications.

15. A method of termination for a single-phase home power factor correction unit of claim 4 comprising:
attaching said home power factor correction unit to a main power panel of a dwelling.

16. A method of termination for the single-phase home power factor correction unit of claim 4 comprising:
A. opening a single-phase overload protection device;
B. electrically connecting said first single-phase lead to a first terminal of said overload protection device;
C. electrically connecting said second single-phase lead to a second terminal of said overload protection device;
D. electrically connecting said ground lead to a power panel ground bus;
E. closing said single-phase overload protection device; and
F. observing the illumination of an indicator light.
